(19) United States
(12) Patent Application Publication
(10) Pub. No.: US 2002/0196923 A1
(43) Pub. Date: Dec. 26, 2002

(54) System and method of call processing

(75) Inventor: Greg Donnelly, Raleigh, NC (US)

Correspondence Address: Pillsbury Winthrop LLP, Intellectual Property Group, 50 Fremont Street, San Francisco, CA, 94105, US

(73) Assignee: LongBoard, Inc., San Jose, CA

(21) Appl. No.: 09/891,070

(22) Filed: Jun. 25, 2001

(51) Int. Cl. H04M 7/00; H04M 3/00

(52) U.S. Cl. 379/219; 379/242

(57) ABSTRACT

A system and method of call processing may implement one or more computer servers or software modules, each of which may be responsible for a limited range of call processing tasks. Group requests, in particular, may be resolved through a distributed call processing system and method. Implementation of one or more dedicated servers or software modules may facilitate group call initiation and management.

### BACKGROUND

1. Field of the Invention

Aspects of the present invention relate generally to call processing in a network environment, and more particularly to a system and method of facilitating server-based call processing services through use of a distributed processing strategy.

2. Description of the Related Art

Recent advances in Internetworking Protocol (IP) data transmission techniques and wireless communications technologies have led to increasing popularity of packet-switched and internet-based telephony and various other call-oriented services. Conventional systems have proposed internet-enabled, or web-enabled, call interfaces which are capable of managing packet-based or IP-based voice and data communications. These systems typically enable IP or web communications services through implementation of a call processing server, i.e. server-side call processing hardware and software operative for call initiation and management.

Conventional server-based call processing methods and hardware platforms are often inadequate to accommodate the volume of communications traffic for which the server is responsible. As new users are attracted to the services provided by the current technology, call volume often increases beyond the limits of the network infrastructure employing conventional techniques; consequently, the frequency and magnitude of communication delays due to network traffic continue to worsen.

### BRIEF DESCRIPTION OF THE DRAWINGS

FIG. 1 is a simplified high-level block diagram illustrating a data communication network environment in which a system and method of call processing may be employed.

FIG. 2 is a simplified high-level block diagram illustrating one embodiment of a computer server arrangement implementing a distributed call processing strategy.

FIG. 3 is a simplified sequence diagram illustrating an exemplary operation executed by one embodiment of a system and method of call processing.

FIG. 4 is a flow chart illustrating the general operational flow employed by one embodiment of a method of call processing.

### DETAILED DESCRIPTION

Embodiments of the present invention overcome various shortcomings of conventional technology, providing a system and method of facilitating server-based call processing services through use of a distributed processing strategy.

In some embodiments, a system and method of call processing may implement a plurality of computer servers or software modules, each of which may be responsible for a limited range of call processing tasks. An Application Program Interface (API) may resolve group requests or treat multiple group members as a unit, for example; operation of the system and method may be transparent to network clients. Implementation of one or more dedicated servers or dedicated software modules may facilitate group call initiation and management.

The foregoing and other aspects of the various embodiments of the present invention will be apparent through examination of the following detailed description thereof in conjunction with the accompanying drawings.

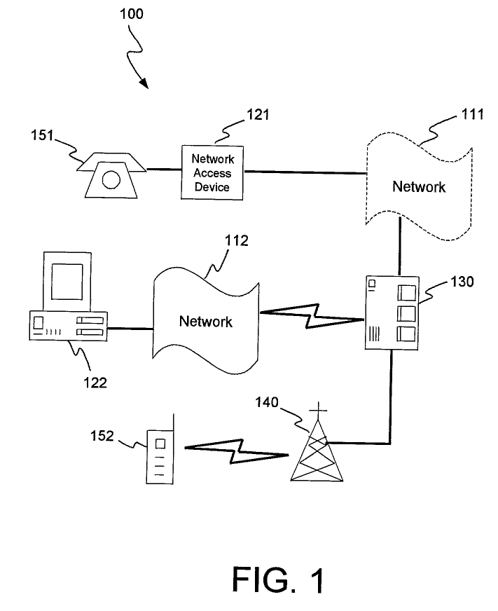

Turning now to the drawings, FIG. 1 is a simplified high-level block diagram illustrating a data communication network environment in which a system and method of call processing may be employed. A communication network 100 may be configured to facilitate packet-switched data transmission of text, audio, video, Voice over IP (VoIP), multimedia, and other data formats known in the art. Network 100 may operate in accordance with various networking protocols, such as Transmission Control Protocol (TCP), Internet Protocol (IP), Hypertext Transfer Protocol (HTTP), Simple Mail Transfer Protocol (SMTP), Asynchronous Transfer Mode (ATM), Real-time Transport Protocol (RTP), Real-time Streaming Protocol (RTSP), Session Announcement Protocol (SAP), Session Description Protocol (SDP), and Session Initiation Protocol (SIP). A method and system of call processing may be employed in conjunction with numerous other protocols known in the art or developed and operative in accordance with known principles.

Network access devices 121 and 122 may be connected via one or more communications networks 111 and 112 enabling two-way point-to-point, point-to-multipoint, or multipoint-to-multipoint data transfer between and among network access devices 121, 122. Additionally, network access devices 121, 122 may be coupled with peripheral devices such as, inter alia, a telephone 151 or wireless telephone 152. Network access devices 121, 122 and any attendant peripheral devices may be coupled via one or more networks 111, 112 as illustrated in FIG. 1.

In some embodiments, for instance, network access devices 121, 122 may be personal desktop or laptop computers, workstations, personal digital assistants (PDAs), personal communications systems (PCSs), wireless telephones, or other network-enabled devices. The scope of the present disclosure is not limited by the form or constitution of network access devices 121, 122; any apparatus known in the art which is capable of data communication on networks 111, 112 is within the scope and contemplation of the inventive system and method.

Each individual network 111, 112 may also include other networkable devices known in the art in addition to telephony infrastructure, such as telephone network server 130 and wireless telephone base station 140. It is well understood in the art that any number or variety of computer networkable devices or components may be coupled to networks 111, 112 without inventive faculty. Examples of other devices include, but are not limited to, the following: servers; computers; workstations; terminals; input devices; output devices; printers; plotters; routers; bridges; cameras; sensors; or any other networkable device known in the art.

Networks 111 and 112 may be any communication network known in the art, including the Internet, a local area network (LAN), a wide area network (WAN), a virtual private network (VPN), or any similarly operating system linking network access devices 121, 122 and similarly capable equipment. Further, networks 111 and 112 may be configured in accordance with any topology known in the art such as, for example, star, ring, bus, or any combination thereof.

Telephone network server 130 may be configured to allow two-way data communication between different networks, such as networks 111 and 112 as depicted in FIG. 1. Additionally or alternatively, telephone network server 130 may communicate with a packet-switched telephone network (PSTN), plain old telephone service (POTS) network, Integrated Services Digital Network (ISDN), or any other telephone network. As illustrated in FIG. 1, telephone network server 130 may be coupled to wireless base station 140 supporting two-way communication between telephone network server 130 and wireless telephone 152.

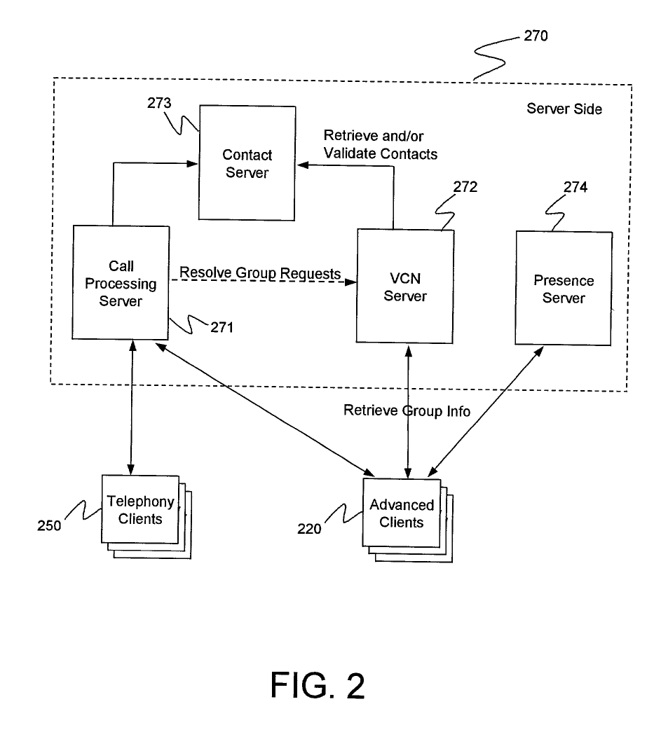

FIG. 2 is a simplified high-level block diagram illustrating one embodiment of a computer server arrangement implementing a distributed call processing strategy. In accordance with this embodiment, a system and method of call processing may generally employ a distributed computer server arrangement 270 comprising, for example, a primary Call Processing Server 271, a Virtual Community Network (VCN) Server 272, a Contact Server 273, and a Presence Server 274.

In one embodiment, server arrangement 270 may be characterized as a tiered server platform having a “master” server which controls the operation of one or more “slave” servers, as is generally known in the art. Alternatively, server arrangement 270 may be non-tiered, or non-hierarchical; that is, the interaction between and among servers 271-274 may be implemented such that no particular server acts as master governing the operation or functionality of the other servers.

Though the simplified server side of a network system is depicted as comprising distributed computer servers 271-274 (each of which may comprise a physical machine embodying one or more microprocessors, memory, storage media, other hardware components, and the like, as is generally known), those of skill in the art will appreciate that server arrangement 270 may comprise as few as one individual computer server. By way of example, in an alternative embodiment, components 271-274 illustrated in FIG. 2 may be implemented as independent, dedicated software modules or firmware or hardware instruction sets residing, for example, on a single physical machine. For simplicity, the FIG. 2 embodiment is discussed herein primarily with reference to dedicated servers, but the disclosure is not intended to be interpreted as being so limited.

With reference to both FIGS. 1 and 2, it will be appreciated that telephony clients 250 may include telephone 151, wireless telephone 152, a PCS or PDA, and other communication hardware discussed above; additionally, advanced clients 220 may generally correspond to computer-based network access devices 121, 122 discussed above. Server arrangement 270 may generally be physically situated on, or accessible through, networks 111, 112. In one embodiment, for example, server arrangement 270 may be integrated into a corporate LAN, WAN, or VPN, and have access to data and resources residing on other servers which are part of the network. In an alternative embodiment, server arrangement 270 may be incorporated into telephone network server 130, for example, or another server forming part of the hardware infrastructure of networks 111, 112.

During network-based call handling operations, call processing tasks may be distributed among the various servers 271-274 such that overall system resources are allocated efficiently. By way of definition, the term “call,” as used herein, may refer to audio transmissions (e.g. radio broadcast or telephone signals), video data, text-based services (e.g. “instant text messaging” or “short message service”), multimedia-based messages, or any other packet-based data communication known in the art.

Calls may be any real-time or near-real-time audio, video, text, or multimedia-based message transmissions across a computer network (i.e. an “on-line” message transmission). Examples of such transmissions include, but are not limited to, user-to-user or user-to-multi-user communications involving electronic conveyance of one or more digital messages such as data packets. Accordingly, examples of calls may include the following: electronic text “chat” or “talk” messaging; electronic-mail; instant text messaging; video conferencing sessions; and internet or other IP-based telephony communications which may employ VoIP. The foregoing list of call types is not intended to be exhaustive, and is provided by way of example only.

Returning to the arrangement depicted in FIG. 2, Call Processing Server 271 may generally provide clients 220, 250 with access to the functionality of server arrangement 270; Call Processing Server 271 may additionally function as a master server or software module, influencing the operating characteristics of the other components in server arrangement 270. In some embodiments, for example, Call Processing Server 271 may handle simple or basic call processing operations, such as setting up calls and terminating calls, for instance, while forwarding more complicated or processor-intensive call processing tasks to other components on the server side. In this embodiment, incoming calls may be directed specifically to an IP address or a telephone number associated with Call Processing Server 271 such that Call Processing Server 271 may invoke call initiation procedures.

Virtual Community Network (VCN) Server 272 may generally function as a “grouping” server, i.e. managing processes involving groups of contacts. In that regard, VCN Server 272 may maintain data records and program instructions enabling grouping or group-related functions based upon contact information. The term “contact” in this sense may refer to personal friends or family members, business associates, professional services representatives and clients, and the like. A contact may be any person, group, or other entity which may be contacted through the communication network. Contact Server 273 may be operative for maintaining or for accessing one or more detailed databases or other data structures (not shown) containing information and data records related to individual contacts. Examples of such data records include, but are not limited to, the following: contact name; one or more telephone numbers; one or more post office, e-mail, or IP addresses; and other personal data.

Whereas Contact Server 273 may be operative to maintain detailed records of individuals as generally described above, VCN Server 272 may maintain information, data, and executable program logic related to groups of individual contacts. In other words, VCN Server 272 may generally function to manage the group abstraction. In operation, for example, VCN Server 272 may conduct processing such as: querying Contact Server 273 for data records associated with one or more individual contacts in a specified group; examining and validating contact and group information; and executing or supervising program procedures related to groups of contacts. The foregoing functionality may be enabled through interaction between VCN Server 272 and Contact Server 273, wherein the latter may provide requested data records to the former for analysis and processing.

By way of example, an advanced client 220 may set up a new group of contacts through program code residing on VCN Server 272. In response to a request to set up such a new group, VCN Server 272 may access data records at Contact Server 273 directly, for example, or may query or otherwise request such data records from Contact Server 273. VCN Server 272 may then validate the existence of individual contacts named as members of the new group specified by client 220; alternatively, VCN Server 272 may create a data record for a previously unknown contact and transmit the new contact information to Contact Server 273 for storage, or request Contact Server 273 to create a data record for a previously unknown contact.

An advanced client 220 having an appropriate User Interface (U1) or Graphical User Interface (GUI) may be permitted to retrieve contact and group information, for example, through VCN Server 272. Data records and other information related to a particular contact and one or more groups with which that contact is associated may be transmitted to advanced client 220 along with all available information related to one or more other contacts associated with the group or groups. Additionally or alternatively, group information may be transmitted with identifying data enabling advanced client 220 to retrieve data records associated with individual contacts in the group.

In accordance with one embodiment, VCN Server 272 may enforce viewing and administrative privileges for individual users attempting to retrieve or to modify the data record contents of a group or any associated individual contacts. Those of skill in the art will appreciate that an advanced client 220 in the FIG. 2 embodiment may be considered an integration point for all of the data residing on the server arrangement 270 of the network system.

By way of example, advanced clients 220 may access and display lists of contacts within one or more groups; further, advanced clients 220 may inspect the content of data records maintained on entire groups or individual contacts associated with accessible groups. In one embodiment, advanced clients 220 may place calls to contacts individually or to some or all of the contacts within a group collectively.

During network sessions, advanced clients 220 may track the presence of group members (i.e. the login status or availability of individual contacts) through Presence Server 274. In this regard, Presence Server 274 may maintain detailed, real-time data records concerning the network login status of contacts in Contact Server 273; accordingly, the login status or availability of a known network subscriber may be transmitted by Presence Server 274 to advanced client 220. Such transmission of presence information may be responsive to a request or a query from advanced client 220, for example. Additionally or alternatively, transmission of presence information to advanced client 220 may occur automatically for the duration of each network session, such as at predetermined time, at a predetermined frequency, or upon the occurrence of some specified event such as contact login or logoff activity, for example.

An integration point between Call Processing Server 271 and VCN Server 272 may enable a system and method of call processing to provide group related services and features to clients 220 and 250 through the grouping functionality of VCN Server 272. Additionally or alternatively, VCN Server 272 may provide public and private grouping information for Presence Server 274 or any other application server (not shown) requiring contact or group information.

In some embodiments, the foregoing functionality may be characterized as an Application Program Interface (API) serving as a front-end to the functional aspects of Call Processing Server 271 and VCN Server 272. The API may manage the group abstraction while remaining transparent to clients 220, 250. For example, an advanced client 220 may initiate a call inviting a group of contacts simultaneously. Though the invitation may be directed initially to a primary call processing engine or logic at Call Processing Server 271 as described above, group processing may be directed to VCN Server 272. By way of example, such group processing may include executing program procedures or instruction sets related to: identifying specific members of the group; extracting data records from one or more databases; confirming an IP address, a Domain Name Server (DNS), or other contact information for each group member; and the like. Appropriate call recipient information may be returned to Call Processing Server 271, and the call may be initiated accordingly. As noted above, the functionality of such an API may be transparent to both the client 220, 250 initiating the call and any clients 220, 250 receiving an invitation to engage in the call.

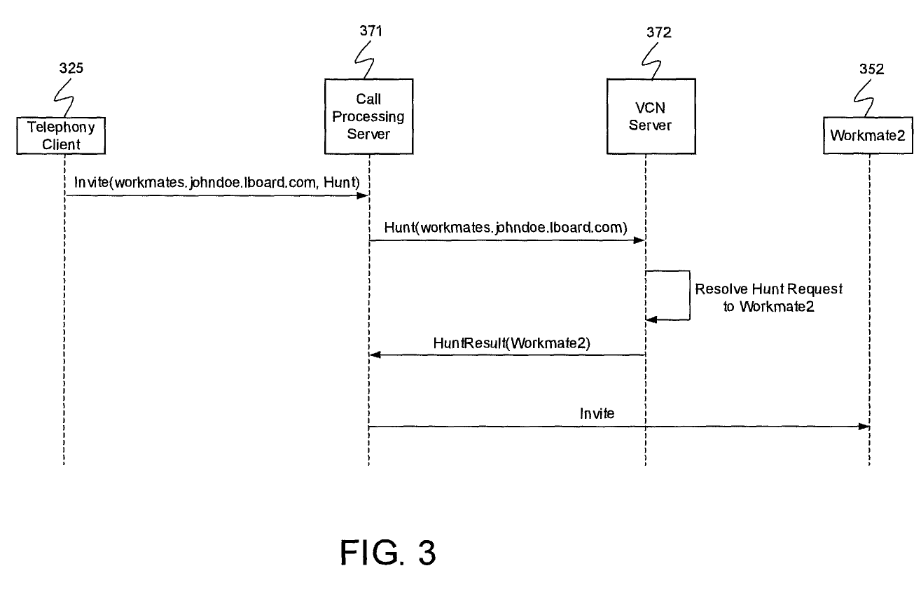

FIG. 3 is a simplified sequence diagram illustrating an exemplary operation executed by one embodiment of a system and method of call processing. The sequence depicted in FIG. 3 represents one example of the manner in which resolution of a hunt request may be conducted through use of a VCN Server 372. In the FIG. 3 embodiment, Call Processing Server 371 and VCN Server 372 may generally correspond to Call Processing Server 271 and VCN Server 272 described above in detail with reference to FIG. 2.

In one embodiment, VCN Server 372 may maintain one or more virtual Communities of Interest (COI), or centrally served logical lists of contacts. Data records for each contact in a COI may be available to authorized viewers of the COI, and such data records, as well as the contacts comprising the COI, may be altered or modified by authorized administrators of the COI. Alternatively, data records for each contact may be maintained at a remote server, such as Contact Server 273 described above with reference to FIG. 2.

As represented by the first interaction in FIG. 3, a telephony client 325 may invite an entire COI directly. Telephony client 325 may be an advanced client 220 or a telephony client 250 described above with reference to FIG. 2. Each member or contact in the COI (e.g. workmates.johndoe.lboard.com in FIG. 3) may be a possible recipient of the invitation. In this embodiment, the invitation maybe routed to Call Processing Server 371, which may then determine that the invitation is directed to a COI rather than to a specific individual. Rather than processing the invitation and hunting for an available call recipient, Call Processing Server 371, responsive to the invitation, may send a request to VCN Server 372 to resolve the hunt request.

In this instance, VCN Server 372 may apply an appropriate algorithm for resolving the request; in resolving such a request, VCN Server 372 may access data records in a contact server or a presence server such as described in detail above with reference to FIG. 2. As illustrated in FIG. 3, VCN Server 372 may then return a specific member of the COI to Call Processing Server 371 as a resolution of the hunt (in FIG. 3, the hunt request is resolved to Workmate2, designated by reference numeral 352). A call processing engine or logic may then cause Call Processing Server 371 to transmit an invitation to the specific member 352 of the COI identified by VCN Server 372.

In some embodiments, the resolution of a hunt request as described above and depicted in FIG. 3 may not be a single specific contact, but rather may be a subset of a group, for example, comprising more than one group member. Accordingly, point-to-multipoint and multipoint-to-multipoint data communication (e.g. telephony conference calls, broadcast voice or text messages, and the like) may be supported, since invitations and any number of server-based software applications may be served to some or all group members simultaneously.

In the foregoing manner, a system and method of call processing may distribute call processing tasks across multiple server hardware platforms, or across multiple software or firmware modules; processing overhead related to group services may be handled by a dedicated server or module, such as VCN Server 272, 372 in the respective embodiments illustrated in FIGS. 2 and 3. In operation, VCN Server 272, 372 or an equivalent software module having similar functionality may resolve requests against a group, i.e. identify a particular member of a group to which a call should be directed, or may retrieve an entire group or a subset thereof for simultaneous treatment, for example, in the serving of applications or administrative functions.

Complicated or processor-intensive tasks may be selectively directed to one or more additional servers or modules, as described above, allowing a simplified call processing engine (residing on Call Processing Server 271, 371, for example) to focus on straightforward call processing tasks such as initiation and termination.

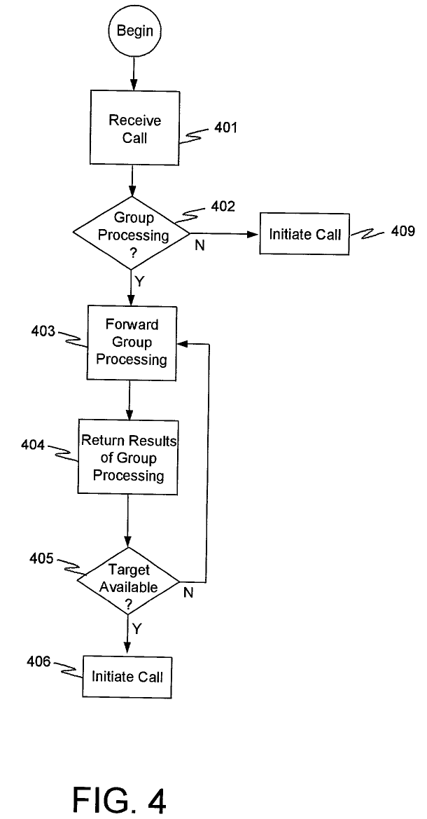

FIG. 4 is a flow chart illustrating the general operational flow employed by one embodiment of a method of call processing. As indicated at block 401, a system and method of call processing may initially receive an incoming call; as described in detail above, such incoming call data packets may generally be directed to a call processing engine residing at a call processing server such as represented by reference numerals 271 and 371 in FIGS. 2 and 3, respectively. At decision block 402, data packets of the incoming call may be examined to determine if any group processing is required to initiate or otherwise to process the call. For example, call data packet header information may be parsed to ascertain recipient address information. Such address information may identify one or more intended recipients of the data packet.

Where no group issues need to be resolved, an invitation may be sent to a specific recipient, and the call may simply be initiated as indicated at block 409. Where group related processing is required, however, group processing functionality as described in detail above may be invoked at block 403; any required group related processing tasks may be forwarded, for instance, to a grouping server (VCN server 272, for example) or to specialized software programs or firmware instructions.

Results of group processing may then be returned to the call processing engine, as indicated at block 404. As described above, the results of group processing may be a resolution of the group request which identifies a specific group member; alternatively, the whole group, or a subset thereof comprising more than one member, may be treated as a unit for the duration of the call. The results referenced in block 404 may be any other group related information required by the call processing engine.

Upon receipt of necessary group information, the call processing engine, for example, may identify a target recipient for call reception; as an alternative, another component, such as a grouping server or a presence server, for example, or some combination of components, may identify the target recipient.

The method of call processing depicted in FIG. 4 may then determine the availability of the identified target as indicated at decision block 405. By way of example, if the target cannot be located by a presence server, the target may not be logged on to the system at the time of the call; alternatively, the target may be logged on to the system, but may be engaged in other network activity or otherwise unavailable. In such instances, the grouping functionality may be invoked again as indicated by the loop back to block 403; an alternative group result may be provided at block 404, for example, by setting a flag associated with the unavailable target. That is, a system and method of call processing may dynamically alter data records associated with each contact to ensure that a known unavailable target will not be identified.

Where a target has been identified and further determined to be available, a call processing method may then initiate the call (as indicated at block 406 in FIG. 4) from the original client to the identified available target. As noted above, multiple targets may be identified, depending upon the results of any group processing at blocks 403 and 404.

Those of skill in the art will appreciate that various alternatives to the FIG. 4 embodiment may be possible. For example, the relative locations of block 404 and decision block 405 may be reversed. In this alternative embodiment, results of group processing activity may not be returned to the call processing engine until independent processing procedures or routines have confirmed availability of one or more targets.

Several aspects of the present invention have been illustrated and described in detail =with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. A method of processing a call in a communications network; said method comprising:
receiving a call directed to one or more intended recipients;
determining whether group processing is required;
responsive to said determining, forwarding group related processing tasks to a group processor;
retrieving results of said group related processing tasks; and
initiating data communication in accordance with said retrieving.

2. The method of claim 1 wherein said receiving includes employing a call processing engine to accept data packets having address information related to said one or more intended recipients.

3. The method of claim 1 wherein said determining includes examining address information associated with said one or more intended recipients to identify a group.

4. The method of claim 1 wherein said forwarding includes requesting said group processor to resolve a group request to a single target recipient selected from said one or more intended recipients.

5. The method of claim 1 wherein said forwarding includes requesting said group processor to manage more than one target recipient selected from said one or more intended recipients as a unit.

6. The method of claim 1 wherein said retrieving includes identifying ones of said one or more intended recipients as available targets.

7. The method of claim 6 wherein said identifying includes extracting data records related to recipient availability from a database.

8. The method of claim 6 wherein said initiating includes establishing data communication with one or more of said available targets.

9. The method of claim 1 wherein said call is transmitted in accordance with Session Initiation Protocol.

10. A call processing system comprising:
a call processing engine executing basic call processing tasks; and
a group processor executing group related processing tasks and returning results to said call processing engine.

11. The system of claim 10 wherein said group processor is responsive to requests from said call processing engine.

12. The system of claim 10 wherein said call processing engine is operative to receive data packets, to identify one or more intended recipients of said data packets, and to transmit identifying information associated with said one or more intended recipients to said group processor.

13. The system of claim 12 wherein said one or more intended recipients are identified according to header information parsed from said data packets.

14. The system of claim 12 wherein said group processor is operative to resolve a group request to one target selected from said one or more intended recipients.

15. The system of claim 14 wherein said call processing engine is operative to initiate a call involving said target.

16. The system of claim 12 wherein said group processor is further operative to determine the availability of said one or more intended recipients and to identify one or more available targets.

17. The system of claim 16 wherein said call processing engine is operative to initiate a call involving ones of said one or more available targets.

18. A server-based call processing system comprising:
a call processing server, having data and a call processing engine residing thereon, identifying one or more intended recipients of a call and executing basic call processing tasks;
a grouping server receiving group related processing requests from said call processing engine; and
a contact server providing data associated with said one or more intended recipients to said grouping server.

19. The system of claim 18 further comprising a presence server maintaining data records related to the availability of said one or more intended recipients.

20. The system of claim 18 wherein said grouping server is operative to resolve a group request to a single target selected from said one or more intended recipients.

21. The system of claim 20 wherein said call processing engine initiates a call involving data communication to said target.

22. The system of claim 18 wherein said grouping server determines the availability of said one or more intended recipients to identify one or more available targets.

23. The system of claim 22 wherein said call processing engine initiates a call involving data communication to ones of said one or more available targets.

24. The system of claim 18 wherein said call is transmitted in accordance with Session Initiation Protocol.

25. A computer-readable medium encoded with data and computer executable instructions for processing a call; the data and instructions causing an apparatus executing the instructions to:
receive a call comprising a plurality of data packets directed to one or more intended recipients;
determine whether said call requires group processing;
forward group related processing tasks to a group processor providing group related processing results; and
initiate data communication in accordance with said group related processing results.

26. The computer-readable medium of claim 25 further encoded with data and instructions, further causing an apparatus to examine address information associated with said one or more intended recipients to identify a group.

27. The computer-readable medium of claim 25 further encoded with data and instructions, further causing an apparatus to resolve a group request to a single target recipient.

28. The computer-readable medium of claim 25 further encoded with data and instructions, further causing an apparatus to manage a plurality of said one or more intended recipients as a unit.

29. The computer-readable medium of claim 25 further encoded with data and instructions, further causing an apparatus to identify ones of said one or more intended recipients as available targets.

30. The computer-readable medium of claim 29 further encoded with data and instructions, further causing an apparatus to establish data communication with one or more of said available targets.

31. A system for processing a call in a communications network; said system comprising:
receiving means for receiving a call directed to one or more intended recipients;
determining means for determining whether group processing is required;
forwarding means for forwarding group related processing tasks to a group processor responsive to output from said determining means;
retrieving means for retrieving results of said group related processing tasks; and
call initiation means for initiating data communication in accordance with said results.

32. The system of claim 31 wherein said receiving means includes a call processing engine operative to accept data packets having address information related to said one or more intended recipients.

33. The system of claim 31 wherein said determining means comprises means for examining address information associated with said one or more intended recipients to identify a group.

34. The system of claim 31 wherein said group processor comprises means for resolving a group request to a single target recipient selected from said one or more intended recipients.

35. The system of claim 31 wherein said group processor comprises means for managing more than one target recipient selected from said one or more intended recipients as a unit.

36. The system of claim 31 further comprising means for identifying ones of said one or more intended recipients as available targets.
